(19) United States
(12) Patent Application Publication
(10) Pub. No.: US 2018/0266697 A1
(43) Pub. Date: Sep. 20, 2018

(54) TOASTER OVEN

(71) Applicant: StoreBound LLC, New York, NY (US)

(72) Inventors: Evan Dash, Port Washington, NY (US); Yiyang Zhang, Brooklyn, NY (US)

(21) Appl. No.: 15/923,405

(22) Filed: Mar. 16, 2018

Related U.S. Application Data
(60) Provisional application No. 62/472,265, filed on Mar. 16, 2017.

(51) Int. Cl. F24C 15/00; F24C 7/06; F24C 15/04; F24C 15/32; A47J 37/06

(52) U.S. Cl. CPC F24C 15/004; F24C 7/062; A47J 37/0641; F24C 15/325; F24C 15/04

(57) ABSTRACT

Described herein is an oven appliance having a top surface with a window extending there-through, and a handle having a display that is oriented at an oblique angle to the window.

### CROSS-REFERENCE TO RELATED APPLICATIONS

This application claims the benefit of U.S. Provisional Application No. 62/472,265, filed Mar. 16, 2017. The disclosure of the above application is incorporated herein by reference.

### BACKGROUND

Toaster ovens comprising doors with a window are known. However, these toaster ovens have set backs in that there is limited visibility through the window into the inside of the toaster oven. As a result, during operation of the user must open the door to check on the progress of the food being cooked therein. Opening the door causes heat to be released from the oven, thereby prolonging the cooking cycle, which wastes time and energy. Additionally, opening the door exposes the user to potential burn injury. Therefore, a need exists for a toaster oven that can provide superior visibility to the interior of the oven without the need for opening the door.

### BRIEF SUMMARY

The present invention provides an oven appliance comprising a cooking chamber located internal a housing assembly, the housing assembly comprising: a first external surface having a first window such that the cooking chamber is visible from the first external surface through the first window, and a first axis extending normal to the first external surface; and a second external surface having a second window such that the cooking chamber is visible from the second external surface through the second window, and a second axis extending normal to the second external surface; wherein the first axis and the second axis are not parallel, and wherein the first major surface of the first transparent panel occupies at least 25% of surface area of the first external surface and wherein the second major surface of the second transparent panel occupies at least 25% of surface area of the second external surface.

In other embodiments, the present invention includes an oven appliance comprising a cooking chamber located internal a housing assembly, the housing assembly comprising: a housing having a top portion opposite a bottom portion and a rear portion opposite a front portion extending between the top and bottom portions, the front portion comprising a front opening and the top portion comprising an upper surface opposite a lower surface and a first opening that extends continuously from the upper surface to the lower surface of the top portion, the first opening defined by a perimeter side wall that extends continuously between the upper and lower surfaces of the top portion; and a first transparent panel having a first major surface opposite a second major surface and a side surface extending between the first and second major surfaces, the first transparent panel is positioned within the first opening of the top wall.

According to other embodiments, the present invention includes oven appliance comprising a cooking chamber located internal a housing assembly comprising: a housing having a top portion opposite a bottom portion, a front portion opposite a rear portion, the front and rear portions extending between the top and bottom portions, the front portion comprising a front opening, the top portion comprising an upper surface opposite a lower surface and a first opening that extends continuously from the upper surface to the lower surface of the top wall; and a first transparent panel positioned within the first opening of the top portion, the first transparent panel having a first major surface opposite a second major surface, each of the first and second major surfaces of the first transparent panel being substantially planar; a second transparent panel position within the first opening of the top portion, the second transparent panel having a first major surface opposite a second major surface, each of the first and second major surfaces of the second transparent panel being substantially planar; wherein the second major surface of the first transparent panel is vertically offset from the first major surface of the second transparent panel.

In other embodiments, the present invention includes an oven appliance comprising a cooking chamber located internal a housing assembly comprising: a housing having a top portion opposite a bottom portion, a first side portion opposite a second side portion, each of the top portion, bottom portion, first side portion, and second side portion having an inner surface opposite an outer surface, whereby the inner surfaces define the cooking chamber, and a first opening extending continuously from the outer surface to the inner surface of the top portion, whereby the first opening circumscribed by a perimeter sidewall; a first linear line located where the perimeter sidewall and the inner surface of the top portion intersect; a second linear line located where the inner surface of the first side portion and the inner surface of the bottom portion intersect; wherein an observation angle exists between a first plane that is coextensive with the inner surface of the first side portion and a second plane that intersects the first and second linear lines, wherein the angle is less than 25°.

Other embodiments of the present invention include an oven appliance comprising a cooking chamber located internal a housing assembly comprising a housing having a top surface having a first window such that the cooking chamber is visible from the top surface through the first window, and a first axis extending normal to the top surface; and a door comprises a handle comprising a display having a first major surface, a second axis extending normal to the major surface of the display; and wherein the first and second axis intersect at an oblique angle and at least a portion of the first major surface of the handle extends above the top surface of the housing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top front perspective view of the toaster oven according to the present invention in a closed state;

FIG. 2 is a bottom rear perspective view of the toaster oven according to the present invention in the closed state;

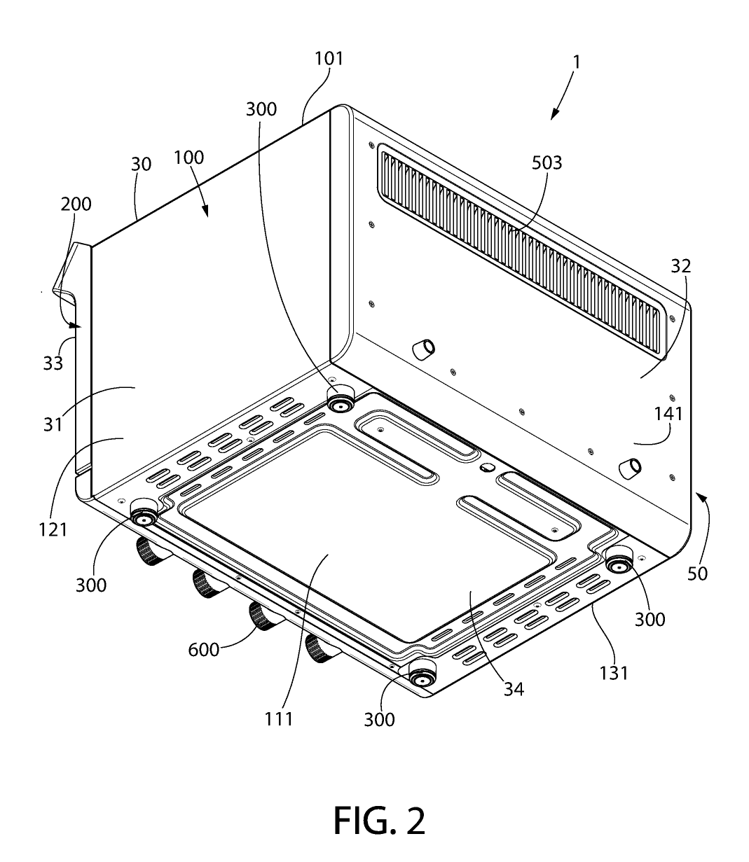

FIG. 3 is a front elevation view of the toaster oven according to the present invention in the closed state;

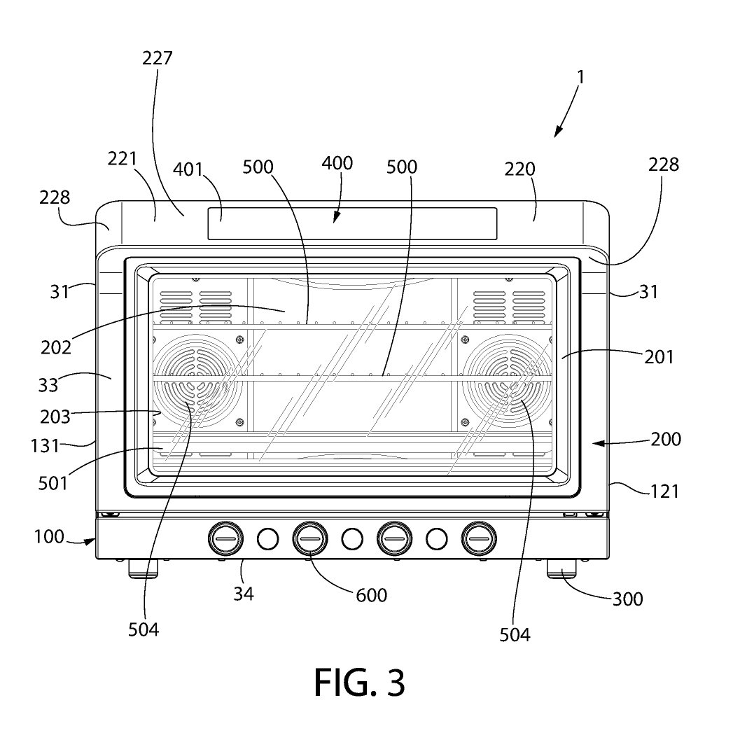

FIG. 4 is a rear elevation view of the toaster oven according to the present invention;

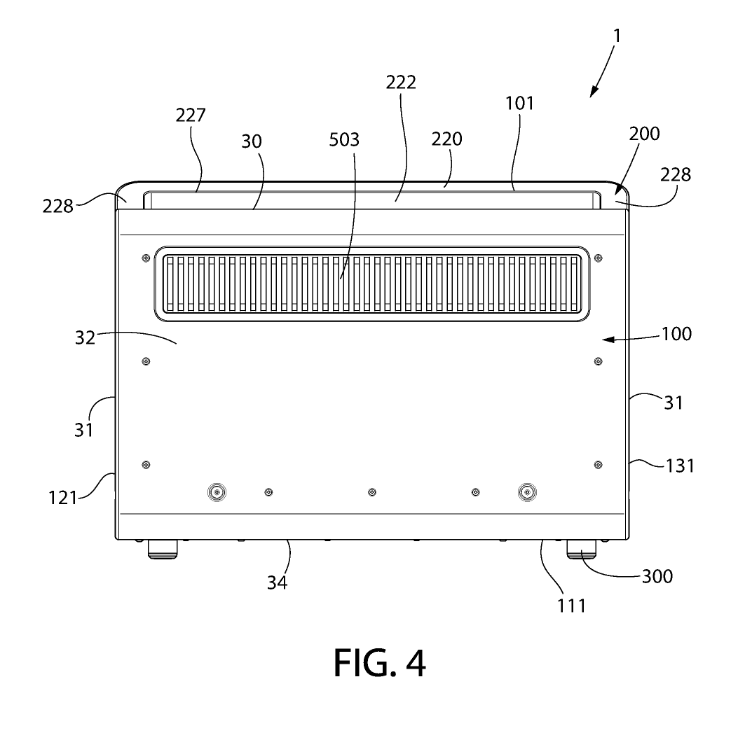

FIG. 5 is a side elevation view of the toaster oven according to the present invention in the closed state;

FIG. 6 is a top front perspective view of the toaster oven in an open state according to the present invention;

FIG. 7 is a side elevation view of the toaster oven according to the present invention in the open state; and

FIG. 8. is a cross-sectional view of the toaster oven according to the present invention as viewed along line IX-IX of FIG. 1; and

FIG. 9. is another cross-sectional view of the toaster oven according to the present invention as viewed along line IX-IX of FIG. 1;

FIG. 10. is another cross-sectional view of the toaster oven according to the present invention as viewed along line IX-IX of FIG. 1;

FIG. 11. is a side elevation view of the toaster oven according to the present invention;

FIG. 12. is cross-sectional view of the toaster oven according to the present invention as viewed along line X-X of FIG. 1; and

FIG. 13. is another cross-sectional view of the toaster oven according to the present invention as viewed along line IX-IX of FIG. 1.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “coupled,” “affixed,” “connected,” “interconnected,” and the like refer to a relationship wherein structures are secured or attached to one another either directly or indirectly through intervening structures, as well as both movable or rigid attachments or relationships, unless expressly described otherwise. According to the present invention, the term “about” refers to ±3% of the referenced value.

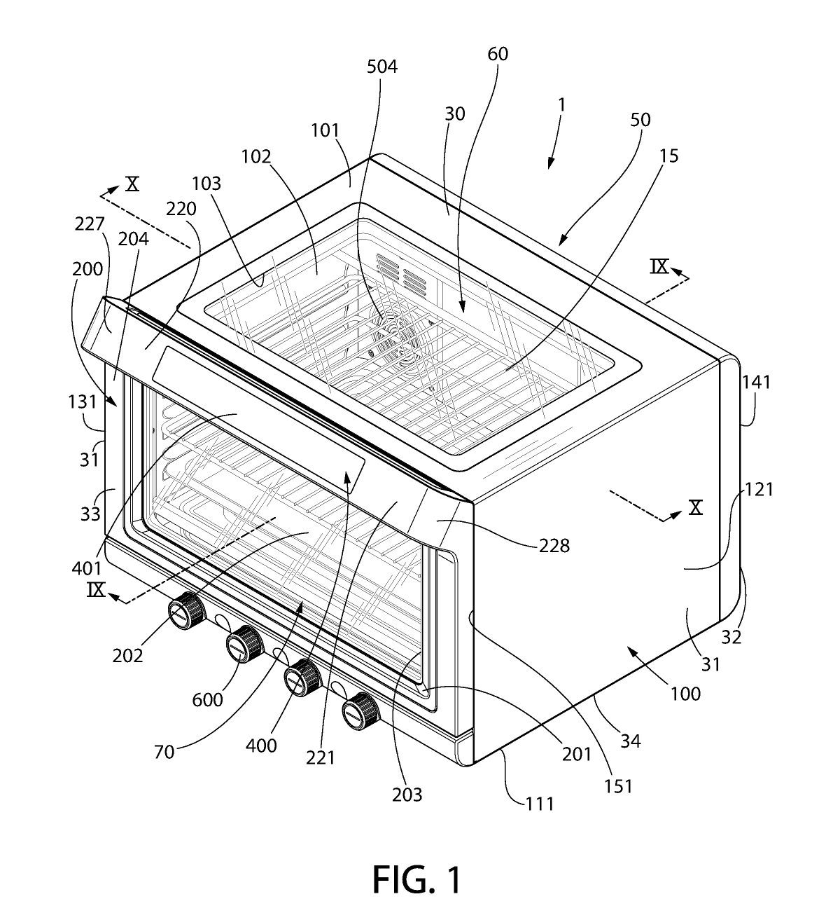

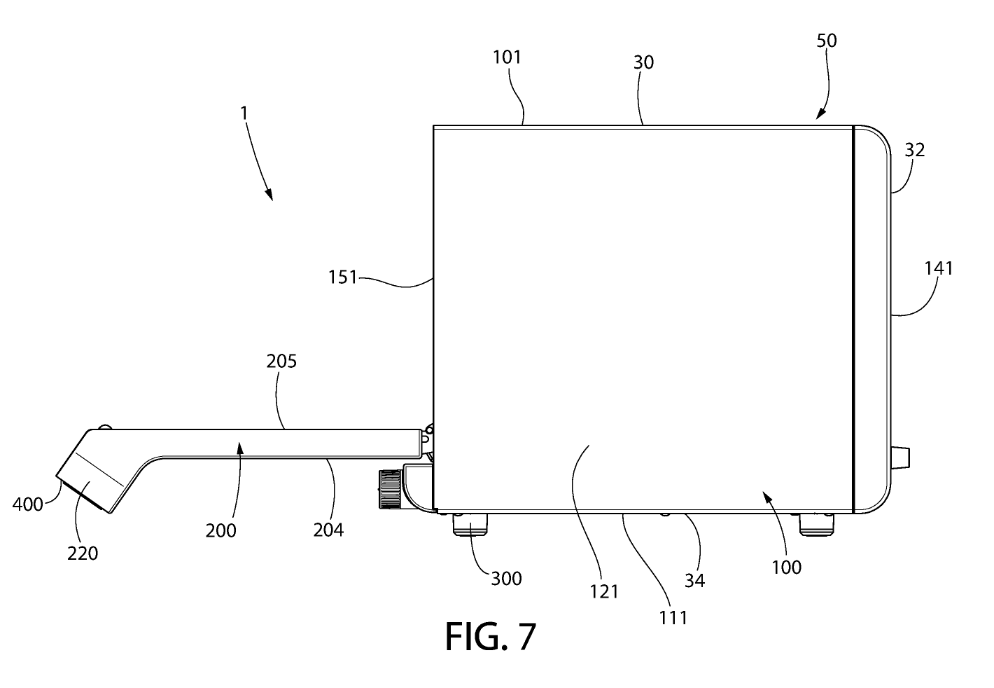

Referring to FIGS. 1 and 7, the present invention is directed to a toaster oven 1 (also referred to as “oven”) for heating and cooking foodstuffs. The oven 1 may comprise a top surface 30 opposite a bottom surface 34, a front surface 33 opposite a rear surface 32, and side surfaces 31. The oven 1 comprises a housing assembly 50 that defines a cooking compartment 10 (also referred to as a “cooking chamber”) and a circulation compartment 11 (also referred to as a “heating chamber”). The housing assembly 50 comprises a housing 100 and at least one transparent panel 102 (also referred to as a “first transparent panel” 102). The housing assembly 50 may further comprise a door 200. The housing 100 may comprise a front portion 151 that includes a front opening 190. The front opening 190 is an open passage way that provides access the cooking compartment 10 from outside of the toaster oven 1 during normal use—as discussed in greater detail herein.

The circulation compartment 11 may be separated from the cooking compartment by a partition wall 12. The partition wall 12 may comprise an opening (also referred to as a “vent”) that extends between the cooking compartment 10 and the heating compartment 11.

A fan 502 may be positioned in the circulation compartment 11 such that air is pulled from a first vent 503 into the circulation compartment 11 and pushed into the cooking compartment 10 via a second vent 504 present on the partition. wall 12. In some embodiments, the circulation compartment 11 may comprise a heat source to heat the air pulled from the first vent 503 before it is delivered to the cooking compartment 11 via the second vent 504. Stated otherwise, the circulation compartment 11 may be fluidly coupled to the cooking chamber 10 by the second vent 504, whereby air may be delivered to the cooking chamber 10 from the circulation compartment 11 via the first and second vents 503, 504. The fan 502 may be configured to pull air from external the oven 1 via the first vent 503 and push the air from the circulation compartment 11 to the cooking chamber 10 via the second vent 504.

The air delivered from the circulation compartment 11 to the cooking compartment 10 creates convection heating to cook the foodstuffs that may be positioned in the cooking compartment 10 of the oven 1 during operation. The first vent 503 may be positioned on the rear surface 32 of the oven 1. In other embodiments, the first vent 503 may be positioned on at least one of the top, bottom, or side surfaces 30, 34, 31 of the oven 1 (not pictured).

The cooking compartment 10 may comprise heating elements 15 that radiate heat directly into the cooking compartment 10. The heating elements 15 may be electrical resistance heaters. In other embodiments, the heating elements 15 may be gas powered (e.g., natural gas). The airflow provided by one or more fans 502 may help distribute the heat generated by the heating elements 15 within the cooking compartment 10.

The top surface 30 of the oven 1 may be substantially parallel to the bottom surface 34. The phrase “substantially parallel” refers to a difference in angle of less than ±3″, preferably a. difference in angle that is less than ±1°; more preferably a difference in angle that zero. Each of the front surface 33, rear surface 32, and side surfaces 31 may extend between the top and bottom surfaces 30, 34. Each of the front, rear, and side surfaces 33, 32, 31 may extend at an angle that is substantially perpendicular to each of the top and bottom surfaces 30, 34. The phrase “substantially perpendicular” refers to 90°±3°, preferably 90°±1°, more preferably 90°. In other embodiments, one or more of the front, rear, and side surfaces 33, 32, 31 may extend at an angle that is oblique to each of the top and bottom surfaces 30, 34.

In addition to the front portion 151, the housing 100 may comprise a rear portion 141 that is opposite the front portion 151. The housing 100 may further comprise a top portion 101 that is opposite a bottom portion 111, as well as a first side portion 121 that is opposite a second side portion 131.

The front portion 151 may intersect the top portion 101 and the bottom portion 111 in a vertical direction. The front portion 151 may intersect the first and second side portions 121, 131 in a horizontal direction. The rear portion 141 may intersect the top portion 101 and the bottom portion 111 in a vertical direction. The rear portion 141 may intersect the first and second side portions 121, 131 in a horizontal direction. The first side portion 121 may extend horizontally between the front portion 151 and the rear portion 141. The second side portion 121 may extend horizontally between the front portion 151 and the rear portion 141. The first side portion 121 may extend vertically between the top portion 101 and the bottom portion 111.

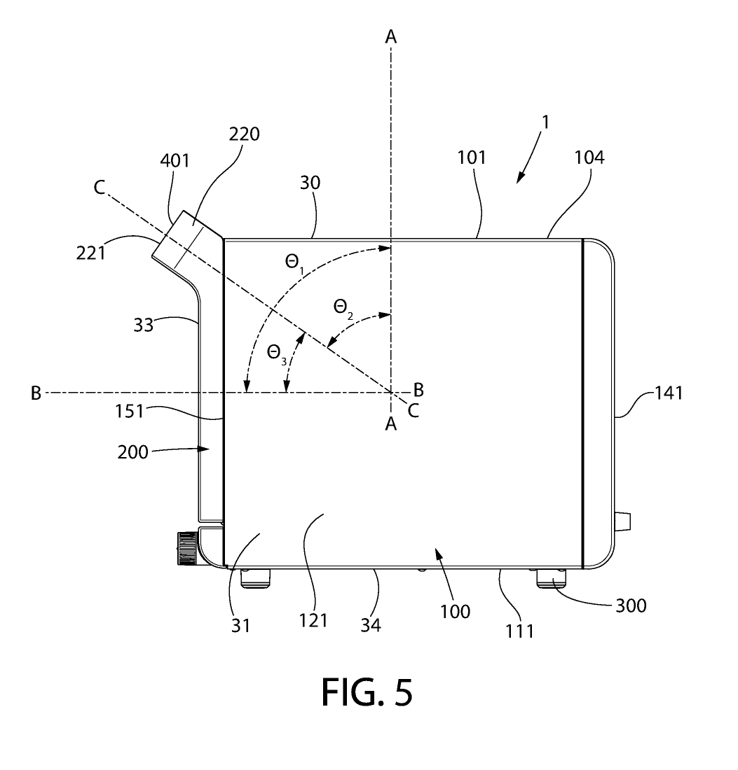

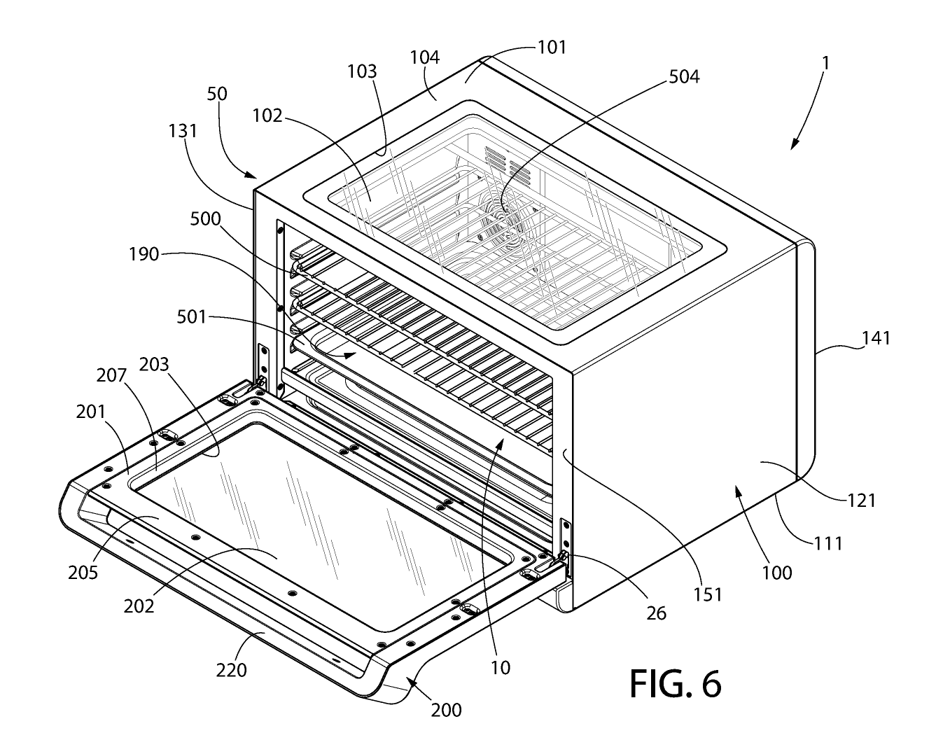

Referring now to FIGS. 6 and 7, the cooking compartment 10 of the oven 1 may be accessed via the front opening 190 by the door 200. The door 200 may be altered between a. closed-state and an open-state. In the closed-state, the cooking compartment 10 is entirely enclosed by the inner surface of the door 200 covering the front opening 190 of the housing as shown in FIGS. 1 and 5. In the open-state, the cooking compartment 10 may be open and accessible to the external environment by the front opening 190 being exposed by the door 200 being held ajar, as shown in FIGS. 6 and 7.

The door 200 may be pivotally connected to the housing 100 by a hinge 20 that is located towards the bottom of the front portion 191 of the housing 100—thereby allowing the door 200 to swing upward and downward between the open and closed states. In other embodiments, the door 200 may be pivotally connected to the housing 100 by a hinge 20 that is located on the front portion 191 of the housing 100 at a point that is adjacent to either the first side portion 111 or the second side portion 121 thereby allowing the door 200 to swing horizontally between the open and closed states (not pictured). In other embodiments, the door 200 may be slideably connected to the housing 100 such that the door 200 may translate horizontally away from the housing 100 in a fixed orientation relative to the housing 100—thereby allowing the door to translate between the open and closed state. In other embodiments, the door 200 may be detachable from the housing 100.

As discussed in greater detail herein, the door 200 may comprise a handle 220 allowing a user to open the door 200 to provide access to the compartment 10. The handle 220 may extend from the first major surface 204 of the door 200. The handle 220 may comprise a display 400. The oven 1 may further comprise a plurality of feet 300 to support the housing 100 in spaced relation to a countertop or other surface. The feet 300 may extend from the bottom portion 111 of the housing 100.

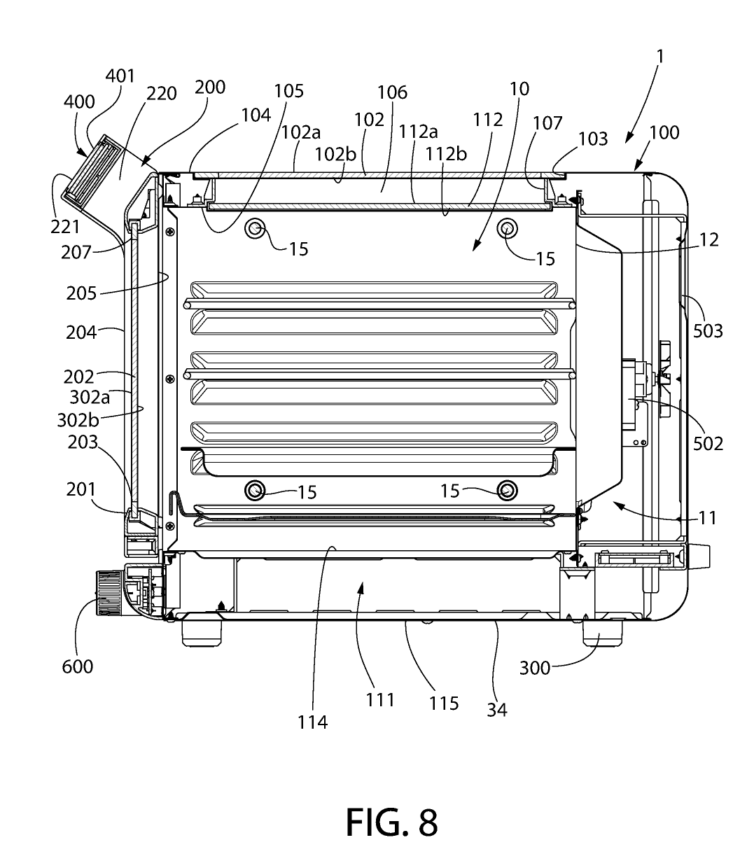

Referring now to FIGS. 1 and 8, the top portion 101 of the housing 100 may have a first major surface 104 opposite a second major surface 105. The first major surface 104 of the top portion 101 of the housing 100 may also be referred to as the “outer surface” 104 of the top portion 101 of the housing 100. The second major surface 105 of the top portion 101 of the housing 100 may also be referred to as the “inner surface” 105 of the top portion 101 of the housing 100.

The first major surface 104 of the top portion 101 may face upward and form part at least a portion of the top surface 30 of the oven 1. The second major surface 105 of the top portion 101 may face the cooking compartment 10 and form a surface that defines a boundary of the three-dimensional space inside of the compartment 10 where foodstuffs are positioned for cooking—i.e., the cooking chamber.

The top portion 101 of the housing 100 may comprise a first opening 103 that extends between the first and second major surfaces 104, 105 of the top portion 101. The first opening 103 may be defined by a first perimeter wall 107 that extends between the first and second major surfaces 103, 105 of the top portion 101. The first perimeter wall 107 may be substantially continuous. The first perimeter wall 107 may comprise various portions positioned at different relative angles—as discussed further herein.

The bottom portion 111 of the housing 100 may have a first major surface 115 opposite a second major surface 114. The first major surface 115 of the bottom portion 111 of the housing 100 may also be referred to as the “outer surface” 115 of the bottom portion 111 of the housing 100. The second major surface 114 of the bottom portion 111 of the housing 100 may also be referred to as the “inner surface” 114 of the bottom portion 111 of the housing 100.

The first major surface 115 of the bottom portion 111 may face downward and form part at least a portion of the bottom surface 34 of the oven 1. The second major surface 114 of the bottom portion 111 may face the cooking compartment 10 and form a surface that defines a boundary of the three-dimensional space inside of the compartment 10 where foodstuffs are positioned for cooking—i.e., the cooking chamber.

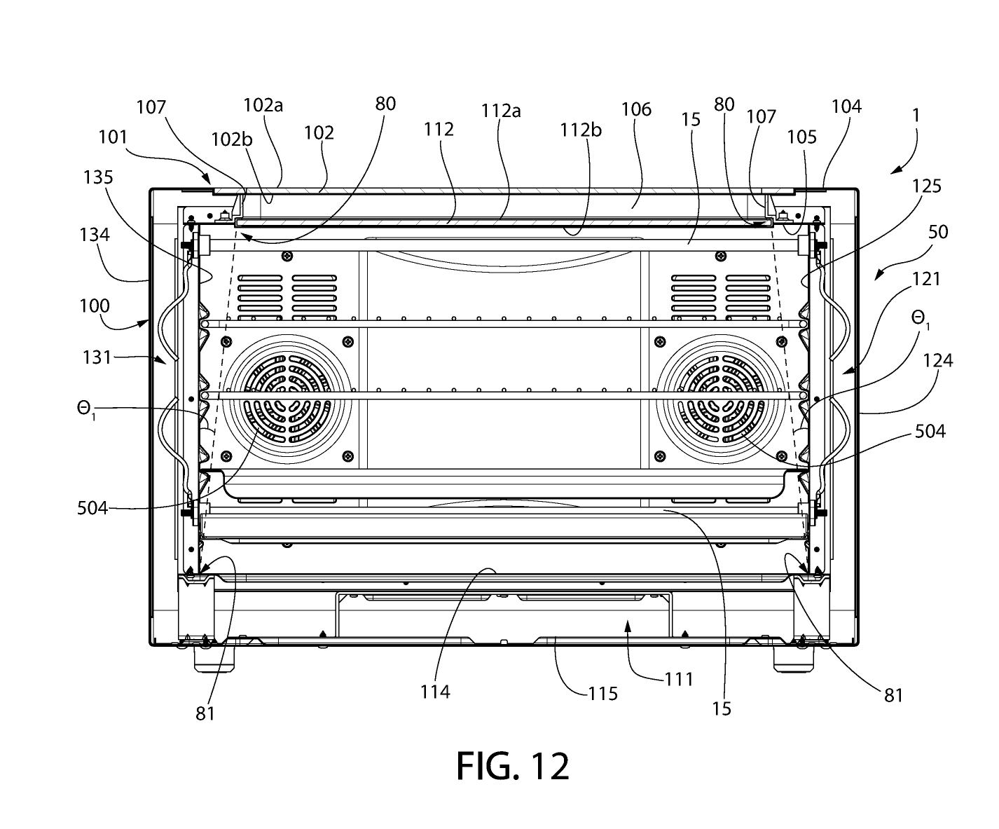

Referring now to FIG. 12, the first side portion 121 of the housing 100 may have a first major surface 124 opposite a second major surface 125. The first major surface 124 of the first side portion 121 of the housing 100 may also be referred to as the “outer surface” 124 of the first side portion 121 of the housing 100. The second major surface 125 of the first side portion 121 of the housing 100 may also be referred to as the “inner surface” 125 of the first side portion 121 of the housing 100.

The first major surface 124 of the first side portion 121 may face outward from the cooking compartment 10 form part at least a portion of the side surface 31 of the oven 1. The second major surface 125 of the first side portion 121 may face the cooking compartment 10 and form a surface that defines a boundary of the three-dimensional space inside of the compartment 10 where foodstuffs are positioned for cooking—i.e., the cooking chamber.

The second side portion 131 of the housing 100 may have a first major surface 134 opposite a second major surface 135. The first major surface 134 of the second side portion 131 of the housing 100 may also be referred to as the “outer surface” 134 of the second side portion 131 of the housing 100. The second major surface 135 of the second side portion 131 of the housing 100 may also be referred to as the “inner surface” 135 of the second side portion 131 of the housing 100.

The first major surface 134 of the second side portion 131 may face outward from the cooking compartment 10 and form part at least a portion of the side surface 31 of the oven 1. The second major surface 135 of the second side portion 131 may face the cooking compartment 10 and form a surface that defines a boundary of the three-dimensional space inside of the compartment 10 where foodstuffs are positioned for cooking i.e., the cooking chamber.

Referring now to FIG. 8, a first transparent panel 102 may be positioned in the first opening 103 of the top portion 101. The first transparent panel 102 may be formed from a substantially transparent material, which refers to a material that is optically clear to the naked eye under normal lighting conditions. Non-limiting examples of such material include glass, tempered glass, or like materials. The term “substantially transparent material” also refers to materials that may be tinted so as to have less than 100% light transmissivity. A non-limiting example of the substantially transparent material is sheets of glass.

The first transparent panel 102 may be positioned adjacent to the first perimeter wall 107 within the first opening 103. The first transparent panel 102 may comprise a first major surface 102a opposite a second major surface 102b. The first and second major surfaces 102a, 102b of the first transparent panel 102 may be substantially parallel. The phrase “substantially parallel” refers to a difference in angle of less than ±1°, preferably a difference in angle that is zero. The first major surface 102a of the first transparent panel 102 may be substantially planar. The second major surface 102b of the first transparent panel 102 may be substantially planar.

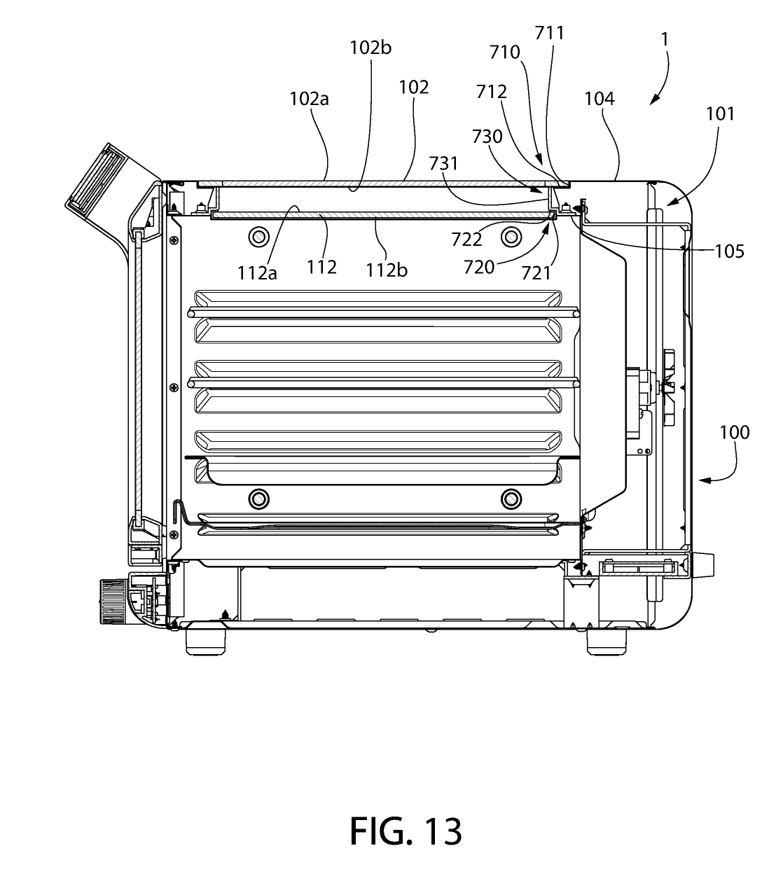

Referring now to FIG. 13, the first perimeter wall 107 may comprise a first portion 710, a second portion 720, and a third portion 730. The first portion 710 of the first perimeter wall 107 extends from the first major surface 104 of the top portion 101 to the third portion 730 of the first perimeter wall 107. The second portion 720 of the first perimeter wall 107 extends from the third portion 730 of the first perimeter wall 107 to the second major surface 105 of the top portion 101. The third portion 730 extends between the first and second portions 710, 720 of the first perimeter wall 107—i.e., the third portion 730 is located between the first and second portions 710, 720.

The first portion 710 may comprise a first mounting geometry that is configured to receive a portion of the first transparent 102. Specifically, the first mounting geometry of the first portion 710 may configured to contact and support the second major surface 102b of the first transparent panel 102.

In a non-limiting embodiment, the first mounting geometry may comprise a first rabbet that extends from the first major surface 104 of the top portion 101 to the third portion 730 of the first perimeter wall 107. The first mounting geometry may comprise a first mounting wall 711 and a first mounting floor 712. The first mounting wall 711 may intersect the first major surface 104 of the top portion 101 of the housing 100 as well as intersect the third portion 730 of the sidewall 107 of the housing 100. The first mounting wall 711 and the first mounting floor 712 may be oriented at a substantially perpendicular angle. In other embodiments, the first mounting wall 711 and the first mounting floor 712 may be oriented at an oblique angle. The first mounting floor 712 may be substantially parallel to the first major surface 104 of the top portion 101. The first mounting wall 711 may be substantially perpendicular to the first major surface 104 of the top portion 101.

The first transparent panel 102 may be positioned adjacent to the first perimeter wall 107 within the first opening 103 such that the first major surface 102a of the first transparent panel 102 may face upwards in the same direction as the first major surface 104 of the top portion 101 of the housing 100. The first major surface 102a of the first transparent panel 102 may be substantially flush with the first major surface 104 of the top portion 101 of the oven housing 100. In other embodiments, the first major surface 102a of the first transparent panel 102 may be vertically offset from the first major surface 104 of the top portion 101 of the oven housing 100 (not pictured) by a first offset distance that is greater than zero. The top surface 30 of the oven 1 may comprise the first major surface 102a of the first transparent panel 102.

The first transparent panel 102 may have a first thickness as measured from the distance between the first major surface 102a and the second major surface 102b. The first mounting geometry may have a first depth as measured by the distance between the first major surface 104 of the top portion 101 and the first mounting floor 712. In some embodiments, the first thickness may be equal to the first depth. In other embodiments, the first thickness and the first depth may be different. In some embodiments, the first thickness may be less than the first depth. In some embodiments, the first thickness may be greater than the first depth.

Once the first transparent panel 102 is inserted into the first opening 103 of the housing 100, the second major surface 102b of the first transparent panel 102 may face the first mounting floor 712. Specifically, the second major surface 102b of the first transparent panel 102 may directly contact the first mounting floor 712 such that the first mounting floor 712 forms a support surface for the first transparent panel 102. Additionally, the first transparent panel 102 may comprise a side surface that extends between the first and second major surfaces 102a, 102b—whereby the side surface faces the first mounting wall 711.

The housing assembly 50 comprises at least the first transparent panel 102 being positioned within the first opening 103 on the top portion 101 of the housing 100. Furthermore, the combination of the first opening 103 and the first transparent panel 102 in the housing assembly 50 forms a first window 60, which the user may use to observe with the naked eye the cooking compartment 10 from outside of the oven 1 through at least a portion of the first transparent panel 102.

The first window GO may define a first open area, which refers to the amount of visible or see-through area available on the top surface 30 of the oven 1. The first open area may be calculated by the open space available between the adjacent-most first perimeter walls 107. The first open area may be equal to about 10% to about 90% of the total surface area of the top surface 30 of the oven 1—including all percentages and sub-ranges there-between. In some embodiments, the first open area may be equal to about 25% to about 75% of the total surface area of the top surface 30 of the oven 1—including all percentages and sub-ranges there-between. In some embodiments, the first open area may be at least 50% of the total surface area of the top surface 30 of the oven 1. In some embodiments, the first open area may be equal to about 25% to about 50% of the total surface area of the top surface 30 of the oven 1 including all percentages and sub-ranges there-between. In some embodiments, the first open area may be equal to about 35% to about 50% of the total surface area of the top surface 30 of the oven 1—including all percentages and sub-ranges there-between.

The door 200 may also comprise a first major surface 204 opposite a second major surface 205. The first major surface 204 of the door 200 may face outward and form part of the front surface 33 of the oven 1. The second major surface 205 of the door 200 may face the cooking compartment 10 and form a surface that partially defines the three-dimensional space of the cooking compartment 10. The door 200 may comprise a second opening 203 that extends between the first and second major surfaces 204, 205 of the door 200. The second opening 203 may be defined by a second perimeter wall 207 of a frame 201, whereby the second perimeter wall 207 extends between the first major surface 204 and the second major face 205 of the door 200.

The door 200 may further comprise a second transparent panel 202 that is positioned in the second opening 203. The second transparent panel 202 may be positioned adjacent to the second perimeter wall 207 within the second opening 203. The second transparent panel 202 may comprise a first major surface 202a opposite a second major surface 202h. The first and second major surfaces 202a, 202b of the second transparent panel 202 may be substantially parallel.

The first major surface 202a of the second transparent panel 202 may face outward and away from the cooking compartment 10. The first major surface 202a of the second transparent panel 202 may face the same direction as the first major surface 204 of the door 200. The front surface 33 of the oven 1 may comprise the first major surface 202a of the second transparent panel 202. The second major surface 202b of the second transparent panel 202 may face inward toward the cooking compartment 10. The second major surface 202b of the second transparent panel 202 may face the same direction as the second major surface 205 of the door 200.

The second transparent panel 202 may be inset on the door 200 such that the first major surface 202a of the second transparent panel 202 is offset from the first major surface 204 of the door 200 by a second offset distance that is greater than zero. In other embodiments, the first major surface 202a of the second transparent panel 202 may be substantially flush with the first major surface 204 of the door 200 of the oven 1 (not pictured).

The combination of the second transparent panel 202 being positioned within the second opening 203 on the door 200 may be referred to as a second window 70, which the user may further observe with the naked eye the cooking compartment 10 from outside of the oven 1 through at least a portion of the second transparent panel 202. According to the present invention, the first and second windows 60, 70 are entirely separate from each other. Further, according to the present invention the combination of the first and second windows 60, 70 creates a unique viewing experience of the cooking compartment 10 as discussed further herein.

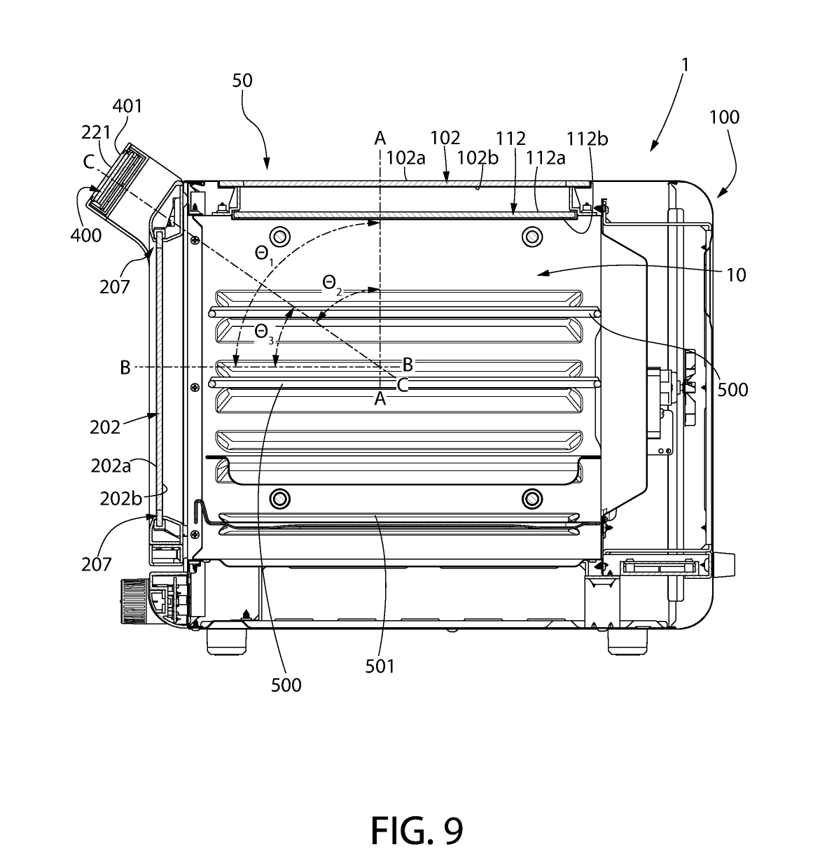

The second window 70 may define a second open area, which refers to the amount of visible or see-through area available on the front surface 33 of the oven 1. The second open area may be calculated by the open space available between the adjacent-most second perimeter walls 207 as shown in FIG. 9. The second open area may be equal to about 10% to about 90% of the total surface area of the front surface 33 of the oven 1 including all percentages and sub-ranges there-between. In some embodiments, the second open area may be equal to about 25% to about 75% of the total surface area of the front surface 33 of the oven 1—including all percentages and sub-ranges there-between. In some embodiments, the second open area may be at least 50% of the total surface area of the front surface 33 of the oven 1. In some embodiments, the second open area may be equal to about 25% to about 50% of the total surface area of the front surface 33 of the oven 1 including all percentages and sub-ranges there-between. In some embodiments, the second open area may be equal to about 35% to about 50% of the total surface area of the front surface 33 of the oven 1—including all percentages and sub-ranges there-between.

A ratio of the first open area to the second open area may ranging from about 3:1 to about 1:3—including all ratios and sub-ranges there-between. A ratio of the first open area to the second open area may ranging from about 2:1 to about 1:2—including all ratios and sub-ranges there-between. A ratio of the first open area to the second open area may ranging from about 1.5:1 to about 1:1.5—including all ratios and sub-ranges there-between. A ratio of the first open area to the second open area may ranging from about 1.4:1 to about 1:1.4—including all ratios and sub-ranges there-between. A ratio of the first open area to the second open area may ranging from about 1.3:1 to about 1:1.3—including all ratios and sub-ranges there-between.

As shown in FIG. 9, the top portion 101 of the housing 100 may further comprise a third transparent panel 112. The third transparent panel 112 may also be positioned in the first opening 103 of the top portion 101. The third transparent panel 112 may also be positioned adjacent to the first perimeter wall 107 within the first opening 103. The third transparent panel 112 may comprise a first major surface 112a opposite a second major surface 112b. The first and second major surfaces 112a, 112b of the third transparent panel 112 may be substantially parallel. The first major surface 112a of the third transparent panel 112 may be substantially planar. The second major surface 112b of the third transparent panel 112 may be substantially planar.

As discussed, the first perimeter wall 107 may comprise a first portion 710, a second portion 720, and a third portion 730. The second portion 720 may comprise a second mounting geometry that is configured to receive a portion of the third transparent 112. Specifically, the second mounting geometry of the second portion 720 may configured to contact the first major surface 112a of the third transparent panel 112.

In a non-limiting embodiment, the second mounting geometry may comprise a second rabbet that extends from the second major surface 105 of the top portion 101 to the third portion 730 of the first perimeter wall 107. The second mounting geometry may comprise a second mounting wall 721 and a second mounting floor 722. The second mounting wall 721 may intersect the second major surface 105 of the top portion 101 of the housing 100 as well as intersect the third portion 730 of the sidewall 107 of the housing 100. The seconding mounting wall 721 and the second mounting floor 722 may be oriented at a substantially perpendicular angle. In other embodiments, the second mounting wall 721 and the first mounting floor 722 may be oriented at an oblique angle. The second mounting floor 722 may be substantially parallel to the second major surface 105 of the top portion 101. The second mounting wall 721 may be substantially perpendicular to the second major surface 105 of the top portion 101.

The third transparent panel 112 may be positioned adjacent to the first perimeter wall 107 within the first opening 103 such that the second major surface 112b of the third transparent panel 112 may face downwards in the same direction as the second major surface 105 of the top portion 101 of the housing 100. The second major surface 112b of the third transparent panel 112 may be flush with the second major surface 105 of the top portion 101 of the oven housing 100 (not pictured). in other embodiments, the second major surface 112b of the third transparent panel 112 may be vertically offset from the second major surface 105 of the top portion 101 of the oven housing 100 by a second offset distance that is greater than zero.

The third transparent panel 102 may have a third thickness as measured from the distance between the first major surface 112a and the second major surface 112b. The second mounting geometry may have a second depth as measured by the distance between the second major surface 105 of the top portion 101 and the second mounting floor 722. In some embodiments, the third thickness may be equal to the second depth. In other embodiments, the third thickness and the second depth may be different. In some embodiments, the third thickness may be less than the second depth. In some embodiments, the third thickness may be greater than the second depth.

Once the third transparent panel 103 is inserted into the first opening 103 of the housing 100, the first major surface 112a of the third transparent panel 112 may face the second mounting floor 722. Specifically, the first major surface 112a of the third transparent panel 112 may directly contact the second mounting floor 722. In some embodiments, the second portion 720 may further comprise a support tab that is positioned beneath the third transparent panel 112, thereby forming a support surface that may contact the second major surface 112b of the third transparent panel. Additionally, the third transparent panel 112 may comprise a side surface that extends between the first and second major surfaces 112a, 112b—whereby the side surface faces the second mounting wall 721. In some embodiments, the second mounting geometry may comprise a groove configured to receive the side surface of the third transparent panel 112, whereby the groove further comprises a support surface that contacts at least a portion of the second major surface 112b of the third transparent panel 112, thereby vertically supporting the third transparent panel 112 within the first window 60.

The housing assembly 50 may comprise the first transparent panel 102 and the third transparent panel 112 being positioned within the first opening 103 on the top portion 101 of the housing 100. The combination of the first opening 103, the first transparent panel 102, and the third transparent panel 112 in the housing assembly 50 may for the first window 60, which the user may use to observe with the naked eye the cooking compartment 10 from outside of the oven 1 through at least a portion of the first transparent panel 102 and the third transparent panel 112.

The first major surface 112a of the third transparent panel 112 may face outward and away from the cooking compartment 10. The first major surface 112a of the third transparent panel 112 may face the same direction as the first major surface 104 of the top portion 101. The second major surface 112b of the third transparent panel 112 may face inward and toward the cooking compartment 10. The second major surface 112b of the third transparent panel 112 may face the same direction as the second major surface 105 of the top portion 101 of the housing 100.

The first transparent panel 102 may have a first surface area as measured by the area occupied by the first major surface 102a of the first transparent panel 102. The area of the first major surface 102a of the first transparent panel 102 may be equal to the area of the second major surface 102b of the first transparent panel 102. The third transparent panel 112 may have a second surface area as measured by the area occupied by the first major surface 112a of the third transparent panel 112. The area of the first major surface 112a of the third transparent panel 112 may be equal to the area of the second major surface 112b of the third transparent panel 102. The first surface area may be equal to the second surface area. In other embodiments, the first surface area may be greater than the second surface area.

The first transparent panel 102 and the second transparent panel 112 may have the same relative shape (e.g., both rectangles), whereby the same relative shape refers to each respective transparent panel sharing the same relative dimensions. Stated otherwise, a ratio of the length and width for the first transparent panel 102 may be equal to a ratio of the length and width of the third transparent panel 112 even though the first surface area may be greater than the second surface area.

According to such embodiments, the first transparent panel 102 may be positioned atop the third transparent panel 112. The first transparent panel 102 may be positioned adjacent to the first major surface 104 of the top portion 101 and the third transparent panel 112 may be positioned adjacent to the second major surface 105 of the top portion 101. The second major surface 102b of the first transparent panel 102 may face the first major surface 112a of the third transparent panel 112. The first transparent panel 102 and the third transparent panel 112 may be substantially parallel.

A gap 106 may exist between the first transparent panel 102 and the third transparent panel 112, whereby the gap 106 is encapsulated by the first perimeter wall 107, the second major surface 102a of the first transparent panel 102 and the first major surface 112a of the third transparent panel 112. The gap 106 may have a height ranging from about 1 mm to about 100 mm as defined by the distance between the second major surface 102b of the first transparent panel 102 and the first major surface 112a of the third transparent panel 112 including all distances and sub-ranges there-between. The gap 106 may be air filled. In other embodiments, the gap 106 may be filled with a different transparent, heat insulating material. The third transparent panel 112 may form part of the first window 60.

Each of the first, second and/or third transparent panels 102, 202, 112 may independently be formed from a substantially transparent material. Non-limiting examples of such material include glass, tempered glass, or like materials. The phrase “substantially transparent material” refers to a material that is optically clear to the naked eye under normal lighting conditions. Additionally, the term “substantially transparent material” refers to materials that may be tinted so as to have less than 100% light transmissivity. Each of the first, second, and third transparent panels 102, 202, 112 may independently have a thickness ranging from about 1 mm to about 10 mm including all thicknesses and sub-ranges there-between. A non-limiting example of the substantially transparent material is sheets of glass.

Referring now to FIGS. 5 and 9, the present invention provides for better observation of the cooking compartment 10 in a closed state (i.e., FIG. 1). Stated otherwise, the oven 1 of the present invention provide for enhanced cooking compartment 10 observation with the naked eye without necessitating that the door 200 being placed into an open state (i.e. as shown in FIG. 6). The enhanced observation of the cooking compartment 10 is achieved by the combination of the first and second windows 60, 70 of the present invention.

Specifically, the first window 60 may be defined as having an orientation that is based on the position of the first transparent panel 102, whereby a first axis of orientation A-A extends normal from the first major surface 102a of the first transparent panel 102. The second window 70 may be defined as having an orientation that is based on the position of the second transparent panel 202, whereby a second axis of orientation B-B extends normal from the first major surface 202a of the second transparent panel 102. The first and second axis of orientations A-A, B-B are not parallel. The first and second axis of orientation A-A, B-B may be offset from each other by a first offset angle Ø₁ that ranges from about 45° to about 135°—including all angles and sub-ranges there-between. In some embodiments, the first offset angle Ø₁ may be about 90°. As such the first and second windows 60, 70 are substantially perpendicular to each other. The result is that a user may have more versatile viewing experience of the cooking compartment 10 while the oven remains in the close state.

Specifically, external light (e.g., ceiling light in a kitchen) may enter the cooking compartment 10 through each of the first and/or second windows 60, 70 to illuminate the cooking compartment 10, thereby allowing the user to readily observe the cooking progress of the foodstuff located therein without needing to move the door 200 into the open state or without necessitating a light source provided internal to the cooking compartment 10. In some embodiments, a light source may be provided within the cooking compartment 10.

Additionally, having both the first and second windows 60, 70 allow for a greater range of viewing angles of the foodstuff contained within the cooking compartment 10 while still being able to maintain the door in the closed state 10. Specifically, the combination of the first and second windows 60, 70 provides for a viewing angle that may range up to about 180° when the door 200 is in the closed state. Additionally, a user may be able to simultaneously observe the cooking compartment 10 through both the first and second windows 60, 70.

The combination of first and second windows 60, 70 allows the user to observe the foodstuffs without needed to open the door 200 into the open state, thereby allowing the heat created by the convection heating system to remain within the cooking compartment 10 (as compared to escaping from the cooking compartment 10 in the open state)—thereby saving cooking time and energy.

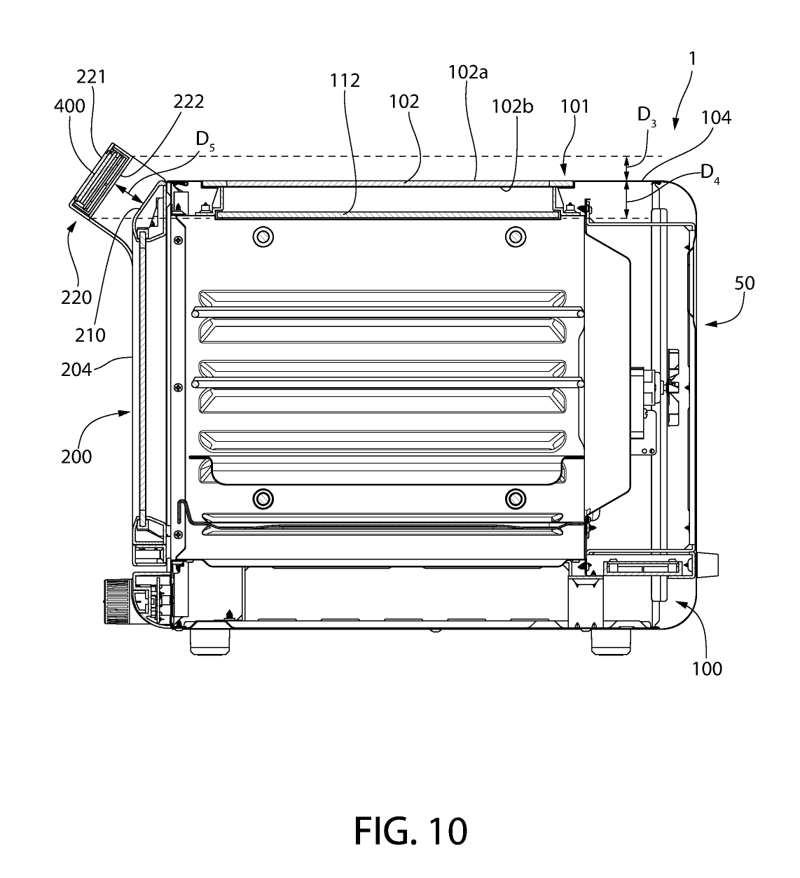

Referring now to FIG. 12, a first intersection line 80 is located where the perimeter sidewall 107 and the inner surface 105 of the top portion 101 intersect. A second intersection line 81 is located where the inner surface 114 of the lower portion 111 and the inner surface 125, 135 of either the first or second side portion 121, 131 intersect. An observation angle Ø₁ exists between a first plane that is coextensive with the inner surface 125 of the first side portion 121 (or the inner surface 135 of the second side portion 131) and a second plane that intersects the first and second intersection lines 80, 81—as demonstrated by the dotted line in FIG. 10. The observation angle Ø₁ may range from about 1° to about 40°—including all angles and sub-ranges there-between. The observation angle Ø₁ may range from about 1° to about 30°—including all angles and sub-ranges there-between. The observation angle Ø₁ may be less than about 30°. The observation angle Ø₁ may be less than about 25°. The observation angle Ø₁ may be less than about 20°. The observation angle Ø₁ may range from about 2° to about 20°—including all angles and sub-ranges there-between. The observation angle Ø₁ may range from about 2° to about 15°—including all angles and sub-ranges there-between. The observation angle Ø₁ may range from about 5° to about 10°—including all angles and sub-ranges there-between.

The oven 1 may further comprise one or more control devices 600. The control device 600 may be a knob, switch, button or combination thereof. The control device 600 may be located on the front surface 33 of the oven 1. In other embodiments, the control device 600 may be located on the side and/or top surface 30, 31 of the oven 1. The control device 600 may control parameters such as cooking temperature, cooking time, and cooking mode (e.g., toasting, baking, broil, or warming). The oven 1 may further comprise one or more grills 500 or baking sheets 501 that can be positioned within the housing 100 to support a foodstuff during cooking.

Additionally, the handle 220 of the oven 1 may comprise a handle body 227 and at least one handle arm 228 that connects the handle body 227 to the frame 201 of the door 200. The handle 200 comprises a first major surface 221 that is opposite a second major surface 222. The handle 200 further comprises a display 400. The first major surface 221 of the handle 220 may be planar. The display 400 may comprise a display surface 401 that is substantially planar.

The handle body 227 may comprise the first major surface 221 and the second major surface 222. The first major surface 221 of the handle 220 may comprise the display 400. The display surface 401 and the first major surface 221 of the handle 220 may be coplanar. The display 400 may provide visual indicia that shares information pertaining to cooking details (e.g., cooking temperature, cooking mode, cooking time). The information may also be non-cooking related, e.g., calendar function showing month, year, and time of day, or weather in specific location. The display 400 may be formed from a LCD screen, LED screen, OLED screen, or the like.

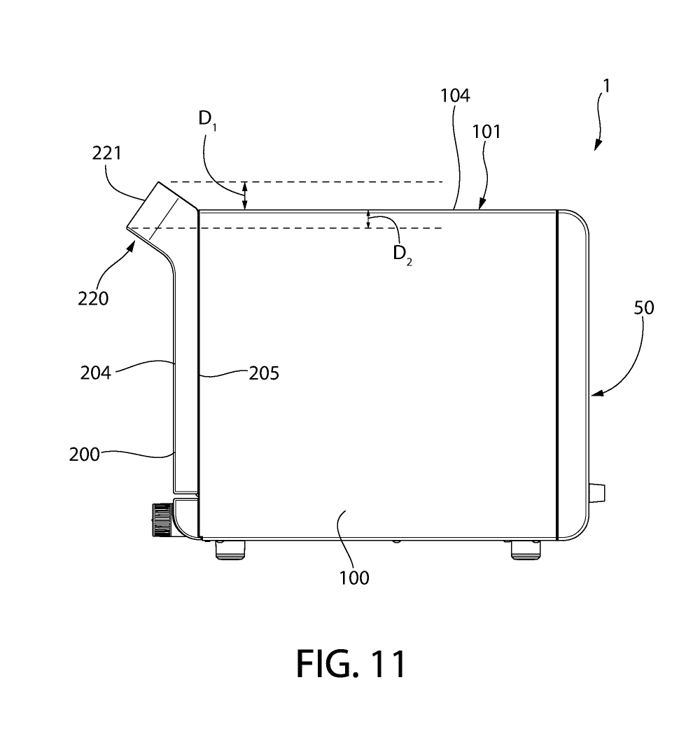

Referring now to FIGS. 10 and 11, the second major surface 222 of the handle 220 may face a top portion 210 of the frame 201, whereby the handle body 228 is connected to the top portion 210 of the frame 201 via the handle arms 228. In the closed-state, an upper portion of the first major surface 221 of the handle 220 may extend above the upper surface 104 of the housing 100 by a first distance D₁—the first distance D₁ being a non-zero value. In the closed-state, a lower portion of the first major surface 221 of the handle 220 may extend below the upper surface 104 of the housing 100 by a second distance D₂—the second distance D₂ being a non-zero value. In the closed-state, an upper portion of the second major surface 222 of the handle 220 may extend above the upper surface 104 of the housing 100 by a third distance D₃—the third distance D₃ being a non-zero value. In the closed-state, a lower portion of the second major surface 222 of the handle 220 may extend below the upper surface 104 of the housing 100 by a fourth distance D₄—the fourth distance D₄ being a non-zero value. The first distance D₁ may be greater than the third distance D₃. The fourth distance D₄ may be greater than the second distance D₂.

In the open-state, both the upper and lower portions of the first major surface 221 of the handle 220 may extend below the upper surface 104 of the housing 100 by a distance that is a non-zero value. In the closed-state, both the upper and lower portions of the second major surface 222 of the handle 220 may extend below the upper surface 104 of the housing 100 by a distance that is a non-zero value.

The second major surface 222 of the handle 220 may be offset from the top portion 210 of the frame 201 by a fifth distance D₅—the fifth distance D₅ being a non-zero value. The fifth distance may remain fixed in both the open and closed states.

The display 400 may be passive or active. A passive display may only function as an output for displaying information pertaining to cooking details. An active display may be capable of functioning as an input device for further controlling cooking parameters—in addition to or as an alternative to the control device 600. Such active displays may be touch-sensitive (also referred to as a “touch-screen”).

The handle 220 may be oriented such that a third axis of orientation C-C extends normal from the major surface 221 of handle 220. The display 400 may be oriented such that the third axis of orientation C-C extends normal from the display surface 401 of display 400. The third axis of orientation C-C may be positioned such that a second offset angle Ø₂ exists between the first axis of orientation A-A and the third axis of orientation C-C. The second offset angle Ø₂ may be an acute angle. In some embodiments, the second offset angle Ø₂ may range from about 10° to about 80°—including all angles and sub-ranges there-between. In some embodiments, the second offset angle Ø₂ may range from about 30° to about 60°—including all angles and sub-ranges there-between.

The third axis of orientation C-C may also be positioned such that a third offset angle Ø₃ exists between the second axis of orientation B-B and the third axis of orientation C-C. The third offset angle Ø₃ may also be an acute angle. In some embodiments, the third offset angle Ø₃ may range from about 10° to about 80°—including all angles and sub-ranges there-between. In some embodiments, the third offset angle Ø₃ may range from about 30° to about 60°—including all angles and sub-ranges there-between. According to some embodiments, the second and third offset angles Ø₂, Ø₃ may sum to a value of about 90°.

The handle 220 may also be oriented to be located at the top of the door 200, thereby resulting in the handle 220 extending above the top surface 30 of the oven 1. The handle 220 may also be oriented to be located at the top of the door 200, thereby resulting in the handle 220 extending above the first major surface 104 of the top portion 101 of the housing 100.

The combination of the handle 220 having the display 400 oriented along the third axis of orientation C-C in combination with the first and second windows 60, 70 provides the user with an enhanced viewing experience when attempting to both operate the cooking functions of the oven 1, as well as observe the progress of the foodstuff being cooked in the cooking compartment 1.

1. An oven appliance comprising a cooking chamber located internal a housing assembly, the housing assembly comprising:
a first external surface having a first window such that the cooking chamber is visible from the first external surface through the first window, and a first axis extending normal to the first external surface; and
a second external surface having a second window such that the cooking chamber is visible from the second external surface through the second window, and a second axis extending normal to the second external surface;
wherein the first axis and the second axis are not parallel, and wherein the first major surface of the first transparent panel occupies at least 25% of surface area of the first external surface and wherein the second major surface of the second transparent panel occupies at least 25% of surface area of the second external surface.

2. The oven appliance according to claim 1, wherein the first axis is normal to the second axis.

3. The oven appliance according to claim 1, wherein the first window comprises a first transparent panel having a first major surface that is opposite a second major surface, the first and second major surfaces being substantially planar.

4. The oven appliance of claim 3, wherein the first external surface comprises the first major surface of the first transparent panel.

5. The oven appliance according to claim 3, wherein the first transparent panel comprises glass.

6. (canceled)

7. (canceled)

8. The oven appliance according to claim 3, wherein the first window comprises a second transparent panel having a first major surface opposite a second major surface, the first and second major surfaces being substantially planar.

9. (canceled)

10. (canceled)

11. (canceled)

12. (canceled)

13. (canceled)

14. An oven appliance comprising a cooking chamber located internal a housing assembly, the housing assembly comprising:
a housing having a top portion opposite a bottom portion and a rear portion opposite a front portion extending between the top and bottom portions, the front portion comprising a front opening and the top portion comprising an upper surface opposite a lower surface and a first opening that extends continuously from the upper surface to the lower surface of the top portion, the first opening defined by a perimeter side wall that extends continuously between the upper and lower surfaces of the top portion; and
a first transparent panel having a first major surface opposite a second major surface and a side surface extending between the first and second major surfaces, the first transparent panel is positioned within the first opening of the top wall.

15. The oven appliance according to claim 14, wherein the housing assembly further comprises a door connected to the housing such that the door can move relative to the housing thereby altering the oven appliance between an open-state and a closed-state, whereby the door at least partially covers the front opening of the housing in the closed-state, and the cooking chamber is accessible through the front opening of the housing in the open-state.

16. (canceled)

17. The oven appliance according to claim 16, wherein the door comprises a second transparent panel having a first major surface opposite a second major surface and wherein a first axis extends normal to the first major surface of the first transparent panel, a second axis extends normal to the first major surface of the second transparent panel, and the first axis and the second axis are not parallel in the closed-state.

18. The oven appliance according to claim 14, wherein the perimeter wall of the top portion comprises a first portion, a second portion, and a third portion, the first portion being adjacent to the upper surface of the top portion, the second portion being adjacent to the lower surface of the top portion, and the third portion being located between the first and second portions.

19. The oven appliance according to claim 18, wherein the first portion comprises a first mounting wall and a first mounting floor, wherein the first mounting wall extends from the upper surface of the top portion to the first mounting floor and the first mounting floor extends from the first mounting wall to the third portion of the perimeter wall.

20. The oven appliance according to claim 19, wherein the second major surface of the first transparent panel faces the first mounting floor and the side surface of the first transparent panel faces the first mounting wall.

21. The oven appliance according to claim 20, wherein the first transparent panel has a first thickness as measured between the first and second major surfaces of the first transparent panel, and the upper surface of the top portion is vertically offset from the first mounting floor for a first depth, the first depth being equal to or greater than the first thickness.

22. The oven appliance according to claim 18, wherein the second portion comprises a second mounting wall and a second mounting floor, the second mounting floor extending from the third portion of the perimeter wall to the second mounting wall and the second mounting wall extending from the second mounting floor to the lower surface of the top portion.

23. The oven applicant according to claim 22, wherein the housing further comprises a third transparent panel having a first major surface opposite a second major surface and a side surface extending between the first and second major surfaces, wherein the first major surface of the third transparent panel faces the second mounting floor and the side surface of the second transparent panel faces the second mounting wall.

24. (canceled)

25. (canceled)

26. (canceled)

27. (canceled)

28. (canceled)

29. An oven appliance comprising a cooking chamber located internal a housing assembly comprising
a housing having a top surface having a first window such that the cooking chamber is visible from the top surface through the first window, and a first axis extending normal to the top surface; and
a door comprises a handle comprising a display having a first major surface, a second axis extending normal to the major surface of the display; and
wherein the first and second axis intersect at an oblique angle and at least a portion of the first major surface of the handle extends above the top surface of the housing.

30. The oven appliance according to claim 29, wherein at least a portion of the first major surface of the handle extends beneath the top surface of the housing by a non-zero distance.

31. The oven appliance according to claim 29, wherein the handle comprises a second major surface opposite the first major surface, wherein at least a portion of the second major surface of the handle extends above the top surface of the housing.

32. The oven appliance according to claim 30, wherein at least a portion of the second major surface extends beneath the top surface of the housing.

33. The oven appliance according to claim 31, wherein the door comprises a front surface and the second major surface of the handle is horizontally offset from the front surface by a non-zero distance.

34. (canceled)

35. (canceled)

36. (canceled)
